(19) United States
(12) Patent Application Publication
(10) Pub. No.: US 2018/0347678 A1
(43) Pub. Date: Dec. 6, 2018

(54) DIFFERENTIAL TRANSMISSION COMPRISING FRICTIONALLY COUPLED POWER OUTLETS

(71) Applicant: Schaeffler Technologies AG & Co. KG, Herzogenaurachq (DE)

(72) Inventors: Dooyong Kim, Tokyo (JP); Kang En Bae, Yokohama-shi (JP)

(73) Assignee: Schaeffler Technologies AG & Co. KG, Herzogenaurach (DE)

(21) Appl. No.: 15/778,437

(22) PCT Filed: Nov. 7, 2016
(86) PCT No.: PCT/DE2016/200500

§ 371 Date: May 23, 2018

(30) Foreign Application Priority Data
Nov. 24, 2015 (DE) 10 2015 223 126.7

(51) Int. Cl. F16H 48/11; F16H 48/22; F16D 13/24

(52) U.S. Cl. CPC F16H 48/11; F16H 2048/104; F16D 13/24; F16H 48/22

(57) ABSTRACT

A differential transmission having an epicyclic housing, a first sun gear in the epicyclic housing, a second sun gear also in the epicyclic housing and arranged on the same axis of revolution as the first sun gear, a planetary assembly revolves around the axis of revolution together with the epicyclic housing and couples the two sun gears such that they can rotate in opposite directions, and a coupling device in a receiving space defined between the sun gears for generating a bridging torque which couples the two sun gears in a frictional manner. The coupling device has a first coupling ring element supported via a conical surface against a first conical inner wall of the receiving space, and a second coupling ring element supported via a conical surface against a second conical inner wall of the receiving space, and a spring arrangement axially loads the two coupling ring elements such that they are pressed against the respective conical inner wall of the receiving space.

### FIELD OF THE INVENTION

The invention refers to a differential transmission comprising an epicyclic housing, a first and a second sun gear, which respectively are accommodated in the epicyclic housing, a planetary assembly rotating with the epicyclic housing about an axis of revolution for coupling the two sun gears such that they can be rotated about said axis of revolution in opposite directions in reference to each other, and a coupling assembly for generating a bridging moment in a friction manner, effective between the outputs of the differential.

### BACKGROUND

Such differential transmissions are used particularly as axial or central differentials in motor vehicles and generally improve the drive stability of the vehicle by a certain frictional coupling occurring of the two outputs of the differential. In case of an axial differential, here an improved straight progression results, as well as an improved acceleration behavior when driving through curves, since in case of a strong release of the wheel at the inside of the curve still at least a torque equivalent to the bridging torque is available at the wheel at the outside of the curve for driving purposes. In case of a central differential here a minimum coupling of the two vehicle axles develops, resulting in any excessive wheel slip being counteracted at the axle with the wheel showing the least ground contact.

A spur gear differential is known from DE 10 2008 050 059 A1 of the applicant. This spur gear differential comprises an actuator mechanism with a pressure ring arrangement, which comprises two pressure rings supported on each other via diagonal areas for generating an axial force engaging a packaged multiple disk coupling. The packaged multiple disk coupling is integrated in the spur gear differential such that with its use one of the sun gears can be coupled in a frictional manner to the epicyclic housing. By the frictional engagement of one of the sun gears with the epicyclic housing, based on another kinematic coupling of the two sun gears via the planetary assembly, overall the effect results that the relative rotation of the two sun gears is braked by a fiction moment and thus a certain frictional coupling of the two sun gears is yielded, i.e. at the outlets of the differential.

A spur gear differential transmission is also known from DE 20 2011 110 104 U1 of the applicant, which comprises two sun gears, which are axially supported via flat spring packages at an epicyclic housing and thus are axially pressed against each other. A friction ring is arranged between the two sun gears, which supports the two sun gears axially in reference to each other and here couples them in a frictional manner.

Another self-locking differential is known for example from U.S. Pat. No. 4,805,487A. In this differential the locking effect is yielded by an appropriate combination of compensating and driven wheels with spur gears and/or worm gears and their inhibition when engaged by gears.

Self-locking differentials of a different type are shown in WO2010/112366 A1. In this case the locking effect is generated via friction elements. The friction elements act upon driven wheels. The friction elements are friction disks and are either arranged at the face between the driving wheels or at the end between the respective driven wheel and the differential cage.

DE 2 206 107 A1 shows a spur gear differential in which the locking effect is generated by a combination of inhibitions when gears engage and friction is in clearance fits. The differential comprises a differential cage, compensating wheels, and driven wheels. A set of compensating wheels is allocated to each driven wheel, by which the respective driven wheel is engaged by gears. Furthermore, one compensation wheel of one set is respectively engaged by gears of a compensation wheel of the other set. The compensation wheels show at the outside helical gearing and are each accommodated in clearance fits of the differential cage in a rotating manner about their own axis of revolution. The clearance fits are formed by pockets in the differential cage, in which the compensation wheels are supported in a rotating fashion either via the external contours of the helical gearing or via shafts with cylindrical exteriors. The clearance fits are sections with cylindrical interiors, with their internal contours forming the sliding fit for the external contours. The internal contours of respectively two pockets are intersecting each other such that the compensation wheels accommodated in these two pockets can engage each other by gears and that furthermore still sufficient space remains for the engagement of gears with the respective driven wheel. When the differential compensates, the respective compensating wheel is supported in a rotating fashion in its clearance fit at the internal contour, resulting in friction developing and thus also the desired locking effect.

DE 196 12 234 A1 shows a transfer case in which the compensation wheels are supported in clearance fits of the differential cage, rotational about their own axis of revolution. The friction effect of the clearance fits in this differential is considered insufficient for the locking effect. For this reasons, in addition to the clearance fits, the friction disks already described in the context with WO2010/112366 A1 are used at the faces and/or ends of the driven wheels.

DE 196 12 234 A1 describes further the use of friction cones, which are formed at friction disks at the ends of the compensation wheels between the respective compensation wheel and the differential cage. By mutually engaging friction cones the friction effect and thus the locking effect can be increased.

In another differential according to U.S. Pat. No. 5,055,096A the self-locking effect is generated in a targeted fashion by the cooperation of gear forces in the differential and friction cones acting against each other between the driven wheels and the differential cage. The compensation wheels are arranged unevenly in the differential. Therefore the resultants of the gear forces of the helical gearing are aligned in the differential such that the gears of the driven wheels are pressed radially outwardly into the clearance fits or support sheaths with clearance fits particularly provided for said purpose. Additionally, the ends of the driven wheels are shifted axially against friction cones, which rest on the differential cage. The driven wheels are provided at the ends with external conical areas, which due to the axial forces are pressed against friction areas inside the cones and complementary thereto, and this way generate the desired locking effect.

### SUMMARY

A sun gear differential transmission of the type mentioned at the outset is provided, which is characterized in a robust and cost-effectively realizable design and in which said transmission can advantageously generate the friction moment interfering the compensating effect.

A differential transmission is provided comprising:
an epicyclic housing,
a first sun gear, which is accommodated in the epicyclic housing,
a second sun gear, which is also accommodated in the epicyclic housing and is arranged on the same axis of revolution in reference to the epicyclic axis of the first sun gear,
a planetary assembly rotating with the epicyclic housing about the axis of revolution to couple the two sun gears such that they can be rotated in opposite directions in reference to each other about said axis of revolution, and
a coupling device accommodated in a receiving chamber defined between the sun gears for generating a bridge moment coupling the two sun gears in a frictional manner,
with
the coupling device comprising a first coupling ring element, which is supported via a conical area on a first conical inner wall of the receiving chamber,
the coupling device comprising a second coupling ring element, which is supported via a conical area on a second conical inner wall of the receiving chamber, and
a spring arrangement being provided for axially stressing the two coupling ring elements such that under the effect of the spring arrangement are urged against the conical inner wall of the receiving chamber.

This way it is possible in an advantageous fashion to create a differential transmission in which the two sun gears can be coupled to each other in a frictional manner by a coupling device surrounded thereby, with the coupling moment being adjustable advantageously via the design of the conical areas, particularly their diameters and the angle of taper, as well as the spring bias.

According to a particularly preferred embodiment of the invention the first conical inner wall is formed directly by the internal circumferential wall of a recess formed in the first sun gear such that the first sun gear surrounds a first half of the receiving chamber. The second inner wall can then be advantageously limited also by an inner circumferential wall of a recess formed in the second sun gear so that the second sun gear then surrounds the second half of the receiving chamber. By this approach a particularly compact embodiment of the differential transmission according to the invention develops and the two sun gears can here be arranged closely adjacent to each other in the axial direction such that the crown gear of the first sun gear is located in the axial plane of the first coupling ring element and the crown gear of the second sun gear is located in the axial plane of the second coupling ring element.

The two coupling ring elements are preferably coupled to each other in an axially displaceable fashion. This coupling can be achieved by complementary gear geometries formed directly at the two coupling ring elements, which can be displaced axially and made to engage each other. The statement “axial” means here the direction of the axis of revolution of the sun gears and the epicyclic housing. It is also possible to couple the two coupling ring elements via a mechanical apparatus, comprising several components, for example an appropriately geared socket. This socket may here comprise external gears, on which the two coupling ring elements are guided in an axially displaceable fashion and torque-proof in reference to each other. In the interior area of this socket then the spring arrangement can be accommodated. The spring arrangement can be produced particularly as a cylindrical coil spring. The spring may also be composed from two nested coil springs, screwed together, so that a symmetric distribution results of the support force. The spring arrangement can furthermore also be realized as a disk spring package or another spring arrangement, particularly produced from a flat material. It is also possible to generate a structure via the spring arrangement which in addition to the required resilient effect also generates a sufficiently torque-proof coupling of the two coupling ring elements.

According to another aspect it is also possible to couple the two coupling ring elements in a kinematic fashion such that any torque acting between these coupling ring elements leads to an increase of the axial stress of the coupling ring elements. This can be yielded for example such that the coupling of the two coupling ring elements is achieved via gears comprising diagonal areas, with these gears then allowing a certain rotation of the ring elements in reference to each other and a movement axially apart by way of rotating the two coupling ring elements.

The differential transmission according to the invention can be realized according to a particularly preferred embodiment of the invention such that the first sun gear comprises a hub section extending axially through the coupling arrangement, with this hub section then being centered in a rotational fashion in a socket section of the second sun gear. This leads to a particularly advantageous support of the first sun gear in the second sun gear. In the interior of the two sun gears, an internal gear may be provided in an advantageous fashion, in which complementarily geared sections of the wheel drive shafts can be inserted.

The epicycle housing can be advantageously designed such that it carries a drive sprocket, with this sprocket then advantageously being located in the axial plane of the two sun gears. The differential transmission is in this design preferably embodied as a spur gear differential, with the crown circle of the first sun gear preferably being smaller than the root gear of the second sun gear. The planets of the planetary assembly may then be designed as spur gears, with each planet engaging the sun gear with the larger crown circle also encompassing the axial plane of the sun gear smaller with regards to its crown circle. The kinematic coupling of each “longer” planet with the “short” planet can then occur in the axial plane of the sun gear that is smaller with regards to its crown circle.

According to another aspect a differential transmission is provided comprising:
an epicyclic housing,
a first sun gear, which is accommodated in the epicyclic housing,
a second sun gear, which is also accommodated in the epicyclic housing and is arranged on the same axis in reference to the axis of revolution of the first sun gear,
a planetary assembly rotating with the epicyclic housing about the axis of revolution to couple the two sun gears such that they can be rotated in opposite directions in reference to each other about said axis of revolution, and
a coupling device accommodated in a receiving chamber defined between the sun gears for generating a bridge moment coupling the two sun gears in a frictional manner,
with
the first sun gear and the second sun gear being respectively embodied as spur gears and the receiving chamber of the coupling device being formed by recesses formed in the first and the second sun gears, and the gearing of the two sun gears surrounding the receiving chamber being in the axial plane of the coupling device.

This way it is possible to generate a spur gear with an integrated bridge coupling, which is characterized in a robust and highly compact design.

The differential transmission may be designed such that the planetary arrangement circulating with the epicyclic housing forms a closed gear drive, i.e. each planet gear engaging a sun gear engages two neighboring planets. This way it is possible to transfer strong torque via the differential transmission at moderate gear loads.

The spur gear differential according to the invention is preferably embodied such that it results in a symmetric power distribution. This is achieved in the teeth counts of the sun gears and the teeth counts of the planetary gears of the planetary assembly engaging these sun gears being adjusted such that between the sun gears a stationary gear ratio of −1 results. In particular, in case of a central differential however a deviating stationary gear ratio may be provided as well, e.g., considering ratios of axial loads, or a different asymmetric distribution of torque.

### BRIEF DESCRIPTION OF THE DRAWINGS

Further details and features of the invention are discernible from the following description in connection with the drawings. Shown are:

FIG. 1 an axially sectioned illustration to show the design of a differential transmission according to the invention with a coupling device comprising external conical coupling rings, with the coupling device being arranged in a receiving chamber surrounded by the sun gears;

FIGS. 2a and 2b a sectional illustration and sketch of forces to explain the system of forces stressing the friction areas, and to explain the generation of the bridge torque;

FIG. 3 an illustration of a detail to show further features of the coupling device as well as the special arrangement thereof “inside” the sun gears;

FIG. 4 a perspective axial cross-section of the first coupling ring element;

FIG. 5 a sketch to illustrate the kinematic coupling of the two coupling ring elements without any additional axial force being generated.

### DETAILED DESCRIPTION

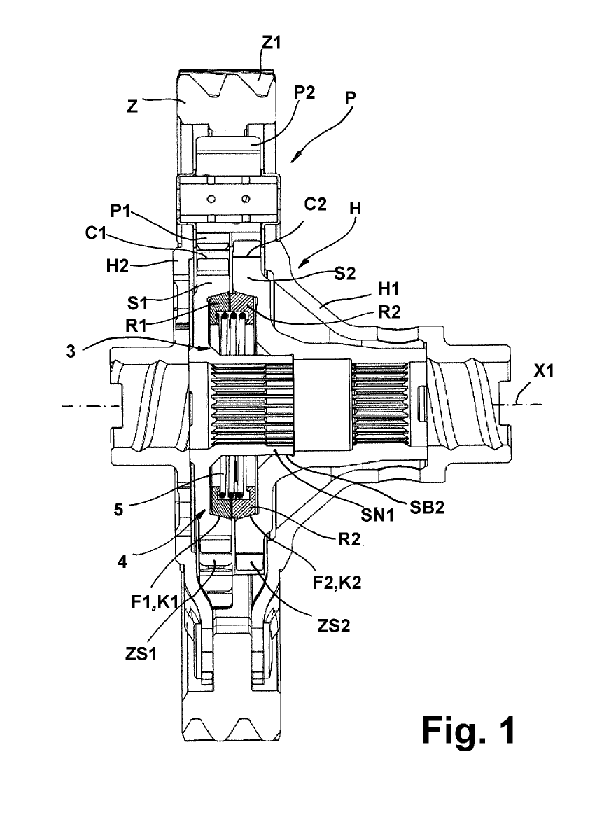

The illustration according to FIG. 1 shows a differential transmission according to the invention with an epicyclic housing H, a first sun gear S1 embodied as a spur gear, which is accommodated in the epicyclic housing H, a second sun gear S2, also embodied as a spur gear, which is also accommodated in the epicyclic housing H, and which is arranged on the same axis in reference to the axis of revolution X1 of the first sun gear S1, and a planetary assembly P rotating with the epicyclic housing H for coupling the two sun gears S1, S2 such that they can be rotated in directions opposite each other.

The epicyclic housing H comprises a first housing side part H1 and a second housing side part 112, as well as a drive sprocket Z. The two housing side parts H1, 112 are located in flat recesses of the drive sprocket Z such that the external edge section of the housing side parts H1, 112 can be lowered below the respective facial area of the drive sprocket Z. This allows a particularly short axial design length of the differential transmission.

The planetary assembly P comprises first planets P1, which engage the first sun gear S1, as well as second planets P2, which engage the second sun gear S2. The first planets P1 engage the second planets P2 in the axial engagement plane of the first sun gear S1. The planets P1, P2 are supported via spur gear journals in the epicyclic housing H. For this purpose bores are formed in the housing side parts H1, 112.

The differential transmission according to the invention is characterized in that a coupling device 4 is accommodated in a receiving chamber 3 surrounded by the sun gears S1, S2, in order to generate a bridging torque coupling in a frictional fashion the two sun gears S1, S2, with the coupling device 4 comprising a first coupling ring element R1, which rests via a conical area F1 at a first conical inner wall K1, which limits the receiving chamber 3. Additionally the coupling device 4 comprises a second coupling ring element R2, which rests via a conical area F2 on a second conical inner wall K2 of the receiving chamber 3. The coupling device 4 comprises also a spring arrangement 5, for applying axial stress upon the two coupling ring elements R1, R2 such that they, under the effect of the spring arrangement 5, are driven axially towards the outside in opposite directions, i.e. away from each other, towards the respectively conical inner wall K1, K2 of the receiving chamber 3. The spring arrangement 5 rests in the interior of the two coupling ring elements R1, R2 and is supported axially at ring steps of the coupling ring elements R1, R2 projecting radially inwardly beyond a cylindrical inner area. The ring steps are located near an axial end section of the respective coupling ring element R1, R2 on each side towards which the respective conical jacket area F1, F2 of the coupling ring element R1, R2 tapers. The ring steps form ring areas at which the spring arrangement 5 is axially supported.

In this exemplary embodiment the first conical internal wall K1 is formed by the inner circumferential wall of the first sun gear S1. The second conical inner wall K2 is formed by an inner circumferential wall of the second sun gear S2. The two sun gears S1, S2 are axially arranged closely neighboring each other such that the crown gear ZS1 of the first sun gear S2 is located in the axial plane of the first coupling ring element R1 and the crown gear ZS2 of the second sun gear S2 is located in the axial plane of the second coupling ring element R2. The two coupling ring elements R1, R2 are coupled to each other in an axially displaceable fashion. The coupling can be achieved via a purely axial gear engagement, or also be yielded such that the two coupling ring elements R1, R2 are coupled to each other such that torque acting between the coupling ring elements results in an axial displacement of the coupling ring elements R1, R2, i.e. in them moving apart and thus an increase develops of the axial stress of the friction areas F1, F2 of the coupling ring elements R1, R2.

The first sun gear S1 comprises a hub section SN1, with it being possible to center this hub section SN1 rotationally in a socket section SB2 of the second sun gear S2. The drive sprocket Z forms a drive sprocket Z1, which is located on the axial level of the two sun gears S1, S2. The differential transmission according to the invention is in this exemplary embodiment formed as a spur gear differential, with the crown circle C1 of the first sun gear S1 being smaller than the root circle C2 of the second sun gear S2. This geometric feature is realized by a profile shift, while the teeth count of the sun gears S1, S2 is identical.

The differential transmission shown in the illustration according to FIG. 1 is characterized, regardless of the special implementation of the coupling device 4 via conical friction areas F1, F2, urged axially apart against the conical inner walls K1, K2 of the sun gears S1, S2, also in that the first sun gear S1 and the second sun gear S2 are respectively embodied as spur gears and the receiving chamber 3 of the coupling device 4 is formed by recesses embodied in the first and the second sun gears S1, S2, and the gears ZS1, ZS2 of the two sun gears S1, S2 surround the receiving chamber 3 on the axial level of the coupling device 4. The respective part of the receiving chamber 3 is therefore axially located behind one of the facial areas of the sun gear S1, S2 respectively facing the adjacent sun gear S2, S1.

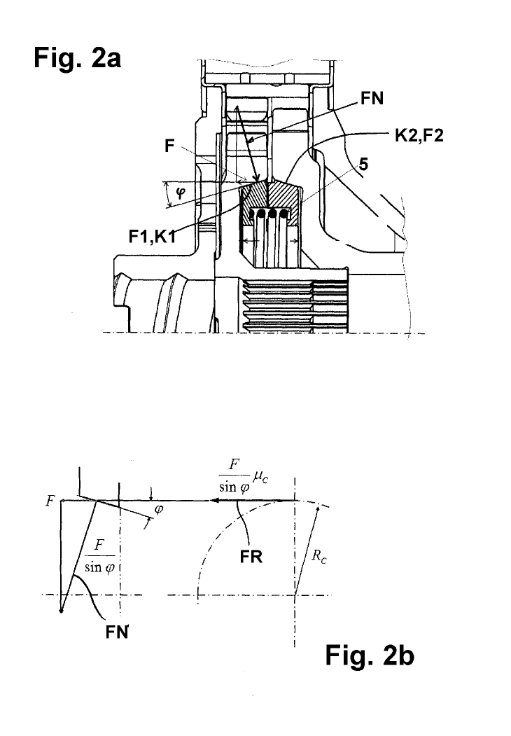

As discernible from the two illustrations according to FIGS. 2a and 2b, it is possible to generate via the bias of the spring arrangement 5 a force system in which the components R1, S1 and R2, S2, respectively being in contact with each other via friction, are stressed with forces FN, which are greater than the spring force F generated by the spring arrangement 5. The angle of taper (I) of the external casing F1, F2 of the respective friction ring element R1, R2 as well as the inner surfaces K1, K2 of the sun gears S1, S2 are embodied such that no self-locking can occur. The friction force FR acting between the friction ring elements R1, R2 and the respective sun gear S1, S2 is here essentially equivalent to the product of the normal force FN (FN=F/sin φ) applied between the friction areas and the friction coefficient μc of the friction pairs. The bridge moment then generated via the coupling device 4 is here equivalent to the product of this friction force FR with the friction area radius Rc, i.e. the average diameter of the respective conical external jacket F1, F2 of the friction ring element R1, R2.

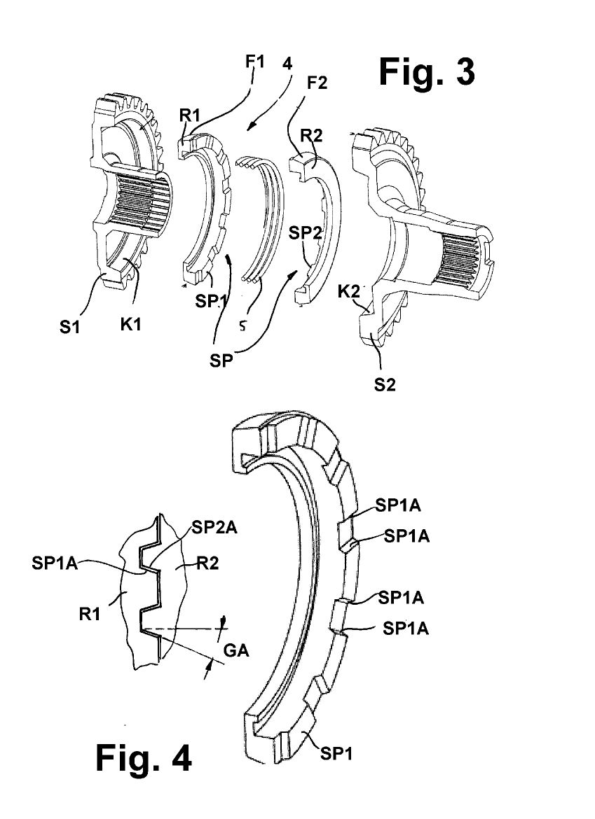

The illustration according to FIG. 3 shows in the form of a perspective image the design of the coupling device 4, which in the assembled state of the transmission is accommodated in the interior chamber surrounded by the sun gears S1, S2. The two external friction ring elements R1, R2 embodied conically are preferably made form a sintered material. The conical external casings F1, F2 of the friction ring elements R1, R2 may be provided with a coating, which in cooperation with the features of the counter walls K1, K2 on the one hand generates the desired friction coefficient and on the other hand allows a relative motion with sufficiently low wear-and-tear.

The two friction ring elements R1, R2 are coupled to each other via gears SP. It comprises first gear geometries SP1, which are embodied at the first friction ring element R1, as well as second gear geometries SP2, which are embodied at the second friction ring element R2. The two gear geometries are formed with essentially complementary geometries, which provide diagonal areas, though, and which allow a slight rotation of the friction ring elements R1, R2 and here lead to an increase of the pressure engaging the walls K1, K2. This gearing SP is here formed at faces of the friction ring elements R1, R2 facing each other.

The illustration according to FIG. 4 illustrates here the coupling gears SP1 provided for coupling the friction ring elements R1, R2 and formed at the first friction ring element R1. This coupling gearing SP1 forms here diagonal areas SP1A, which in case of a relative rotation of the sun gears S1, S2 lead to an increase of the force applied to the friction areas. The diagonal areas SP1A of the coupling gears SP1 of the first friction ring element R1 are here supported in the circumferential direction on the diagonal areas SP2A of the coupling gearing SP2 of the second friction ring element R2, forming a diagonal area or wedge system. The wedge angle GA ranges preferably from 5 to 25°. The parameters of the coupling device can be adjusted and optimized by the selection of the angle of taper, the resilience, and the friction coefficient of the contact areas. The bridging moment is here adjusted, e.g., with regards to the inertia of the section of the drive train located in the power flow downstream the respective sun gear as well as the torque requirements of the wheel drive shafts. The conical areas may be coated with a material offering a high friction coefficient and high resistance to wear and tear, such as a MO-coating, carbon coating, or titanium coating. The diagonal engagement of the gears provide the differential with a progressive characteristic, the mechanical features of the differential transmission can be adjusted to the respective vehicle type, depending on the selection of the angle and other geometric parameters.

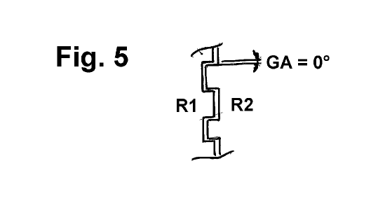

The illustration according to FIG. 5 shows a coupling of the two friction ring elements R1, R2 via a gearing, which does not include a diagonal area engagement system. The wedge angle GA amounts here to 0°. In this embodiment the force pushing by the friction ring elements F1, F2 against the conical inner walls K1, K2 of the sun gears S1, S2 is exclusively generated by the spring arrangement 5 (cf. here FIG. 1). This variant of the coupling device shows, unlike the exemplary embodiment according to FIG. 4, no progressive characteristic.

### LIST OF REFERENCE CHARACTERS

3 Receiving chamber

4 Coupling device

5 Spring arrangement

C1 Crown circle

C2 Root circle

F Resilience

FN Force

FR Friction force

H Epicyclic housing

H1 Housing side part

H2 Housing side part

K1 Inner wall

K2 Inner wall

P Planetary assembly

P1 Planets

P2 Planets

R1 Coupling ring element

R2 Coupling ring element

Rc Radius of friction area

S1 Sun gear

S2 Sun gear

SN1 Hub section

SB2 Socket section

SP Gearing

SP1 Coupling gears

SP2 Coupling gears

SP1A Diagonal areas

SP2A Diagonal areas

X1 Axis of revolution

Z Drive sprocket

Z1 Drive crown

ZS1 Crown gear

ZS2 Crown gear

1. A differential transmission comprising:
an epicyclic housing;
a first sun gear accommodated in the epicyclic housing;
a second sun gear also accommodated in the epicyclic housing and arranged on a same axis in reference to an axis of revolution of the first sun gear;
a planetary assembly that rotates with the epicyclic housing about the axis of revolution that couples the two sun gears to allow rotation in opposite directions in reference to each other about said axis of revolution; and
a coupling device accommodated in a receiving chamber defined between the sun gears to generate a bridge moment coupling the two sun gears in a frictional manner;
the coupling device comprising:
a first coupling ring element supported via a conical area at a first conical inner wall that limits the receiving chamber;
a second coupling ring element supported via a conical area at a second conical inner wall that limits the receiving chamber; and
a spring arrangement that axially stresses the two coupling ring elements such that under an effect of the spring arrangement the first and second coupling ring elements are each urged against the respective first or second conical inner walls.

2. The differential transmission according to claim 1, wherein the first conical inner wall is formed by an inner circumferential wall of the first sun gear.

3. The differential transmission according to claim 2, wherein the second conical inner wall is formed by an inner circumferential wall of the second sun gear.

4. The differential transmission according to claim 1, wherein the two sun gears are arranged in axial proximity to each other, and a crown gear of the first sun gear is located in an axial plane of the first coupling ring element and a crown gear of the second sun gear is located on an axial plane of the second coupling ring element.

5. The differential transmission according to claim 1, wherein the first and second coupling ring elements are coupled to each other in an axially displaceable fashion.

6. The differential transmission according to claim 1, wherein the first and second coupling ring elements are coupled to each other such that a torque applied between said first and second coupling ring elements leads to an increase of an axial stress of the first and second coupling ring elements.

7. The differential transmission according to claim 1, wherein the first sun gear comprises a hub section and said hub section is centered in a rotational fashion in a socket section of the second sun gear.

8. The differential transmission according to claim 1, wherein the epicyclic housing carries a drive sprocket located in an axial plane of the two sun gears.

9. The differential transmission according to claim 1, wherein the differential is embodied as a spur gear differential and a crown circle diameter of the first sun gear is smaller than a root gear diameter of the second sun gear.

10. A differential transmission comprising:
an epicyclic housing;
a first sun gear accommodated in the epicyclic housing;
a second sun gear also accommodated in the epicyclic housing (H) and arranged on a same axis in reference to an axis of revolution of the first sun gear;
a planetary assembly that rotates with the epicyclic housing about the axis of revolution that couples the two sun gears for rotation in opposite directions in reference to each other about said axis of revolution; and
a coupling device accommodated in a receiving chamber defined between the sun gears that generates a bridge moment coupling the two sun gears in a frictional manner;
the first sun gear and the second sun gear each being embodied as spur gears and arranged in proximity to and axially following each other, and the receiving chamber of the coupling device is formed by plate-shaped recesses formed in the first and the second sun gear, and crown gears of the two sun gears surround the receiving chamber in an axial plane of the coupling device.

11. The differential transmission of claim 10, wherein a crown gear of the first sun gear is located in an axial plane of the first coupling ring element and a crown gear of the second sun gear is located on an axial plane of the second coupling ring element.

12. The differential transmission of claim 10, wherein the first and second coupling ring elements are coupled to each other in an axially displaceable fashion.

13. The differential transmission of claim 10, wherein the first and second coupling ring elements are coupled to each other such that a torque applied between said first and second coupling ring elements leads to an increase of an axial stress of the first and second coupling ring elements.

14. The differential transmission of claim 10, wherein the first and second coupling ring elements including coupling gearing on facing axial sides thereof, and the coupling gearing of the first coupling ring element engages the coupling gearing of the second coupling ring element.

15. The differential transmission of claim 10, wherein the coupling gearing of the first and second coupling ring elements include teeth having diagonal circumferential end faces that contact one another to form a wedge system.

16. A differential transmission comprising:
an epicyclic housing;
a first sun gear located in the epicyclic housing;
a second sun gear also located in the epicyclic housing and arranged on a same axis of revolution as the first sun gear;
a planetary assembly that rotates with the epicyclic housing about the axis of revolution that couples the first and second sun gears to allow rotation in opposite directions in reference to each other about said axis of revolution; and
a coupling device located between the sun gears that frictionally couples the first and second sun gears in a frictional manner, the coupling device comprising:
a first coupling ring element supported via a conical area at a first conical inner wall located on the first sun gear;
a second coupling ring element supported via a conical area at a second conical inner wall located on the second sun gear; and
an elastic element that axially stresses the two coupling ring elements against the respective first or second conical inner walls.

17. The differential transmission of claim 16, wherein a crown gear of the first sun gear is located in an axial plane of the first coupling ring element and a crown gear of the second sun gear is located on an axial plane of the second coupling ring element.

18. The differential transmission of claim 16, wherein the first and second coupling ring elements are coupled to each other in an axially displaceable fashion.

19. The differential transmission of claim 16, wherein the first and second coupling ring elements are coupled to each other such that a torque applied between said first and second coupling ring elements leads to an increase of an axial stress of the first and second coupling ring elements.

20. The differential transmission of claim 16, wherein the first and second coupling ring elements including coupling gearing on facing axial sides thereof, and the coupling gearing of the first coupling ring element engages the coupling gearing of the second coupling ring element.
